(19) United States
(12) Patent Application Publication
(10) Pub. No.: US 2010/0131627 A1
(43) Pub. Date: May 27, 2010

(54) METHOD AND APPARATUS FOR RECONFIGURING APPLICATION SERVICES IN HOME NETWORK ENVIRONMENT

(76) Inventors: Young Sung SON, Daejeon (KR); Kyeong Deok MOON, Daejeon (KR)

Correspondence Address: LADAS & PARRY LLP, 224 SOUTH MICHIGAN AVENUE, SUITE 1600, CHICAGO, IL, 60604, US

(21) Appl. No.: 12/465,815

(22) Filed: May 14, 2009

(30) Foreign Application Priority Data
Nov. 25, 2008 (KR) 10-2008-0117355

(51) Int. Cl. G06F 15/177; G06F 15/173

(52) U.S. Cl. 709/221; 709/224

(57) ABSTRACT

A method for reconfiguring services in a home network environment where plural devices included in a device group operate in conjunction with application services includes analyzing an application service script; collecting home network status information through the home network environment; and matching the application service script with the home network status information to generate a corrected application service execution plan.

### CROSS-REFERENCE(S) TO RELATED APPLICATION(S)

The present invention claims priority of Korean Patent Application No. 10-2008-0117355, filed on Nov. 25, 2008, which is incorporated herein by reference.

### FIELD OF THE INVENTION

The present invention relates to a service control technology in a home network environment where plural devices operate in conjunction with application services, and more particularly, to a method and apparatus for reconfiguring application services in home network environment, which are suitable for effectively changing and operating an application service script based on home network configuration information in the home network environment.

### BACKGROUND OF THE INVENTION

In application services offered in home network environment, there are diverse platforms and services such as a broadcasting service, a home care service, an appliance control service, and a home entertainment service.

In the home network environment offering such diverse types of services, a technology that can efficiently manage and control each of the services is essentially required, but existing service technologies have a limitation that does not actively cope with the addition of new services.

### SUMMARY OF THE INVENTION

In view of the above, the present invention provides a method and apparatus for reconfiguring application services in home network environment, which are capable of effectively controlling a home network by using home network configuration information.

Further, the present invention provides a method and apparatus for reconfiguring application services in home network environment, which are capable of operating the application service suitable for the home network environment by correcting an application service script based on configuration information of devices, networks, systems, and services.

In accordance with one aspect of the present invention, there is provided a method for reconfiguring service in a home network environment where plural devices included in a device group operate in conjunction with application services, including:

analyzing an application service script;

collecting home network status information through the home network environment; and

matching the application service script with the home network status information to generate a corrected application service execution plan.

In accordance with another aspect of the present invention, there is provided an apparatus for reconfiguring services in a home network environment, including:

a home network management unit for managing home network status information of any of devices included in a device group connected to a home network;

an application service script server for managing an application service script; and

an application service reconfiguration unit for analyzing the application service script, and matching the analyzed application service script with the home network status information to generate a corrected application service execution plan.

### BRIEF DESCRIPTION OF THE DRAWINGS

The above and other objects and features of the present invention will become apparent from the following description of embodiments, given in conjunction with the accompanying drawings, in which:

FIG. 1 illustrates a block diagram of an apparatus for reconfiguring application services in home network environment in accordance with one embodiment of the present invention;

FIG. 2 provides a detailed block diagram of the application service reconfiguration unit depicted in FIG. 1;

FIG. 3 shows a flow chart for a process of generating a service execution plan in accordance with another embodiment of the present invention; and

FIG. 4 offers a flow chart for a process of regenerating a service execution plan depending on whether there is a change in home network status information.

### DETAILED DESCRIPTION OF THE EMBODIMENTS

As will be described below, the present invention is characterized by managing home network environment with home network information on each of devices, networks, systems, and services, and analyzing an application service script related to those home network information to automatically correct a service execution plan.

Particularly, the application service script is analyzed to prepare the service execution plan to operate devices, networks, systems and services.

Home network status information on devices, networks, systems, and services is recognized to generate home network configuration information, thereby establishing the execution plan which is suitable for the analyzed application service script.

The devices, networks, systems, and services are executed in accordance with the service execution plan.

Accordingly, the execution plan can be conducted by effectively correcting a single application service script thereby meeting various types of home networks.

Hereinafter, exemplary embodiments of the present invention will be described in detail with reference to the accompanying drawings.

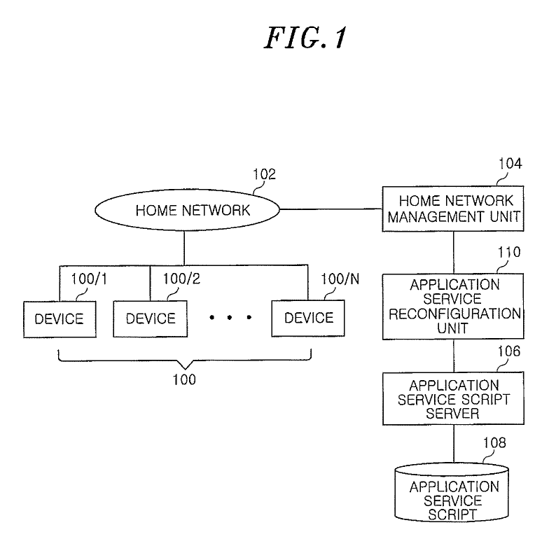

FIG. 1 illustrates a block diagram of an apparatus for reconfiguring application services in home network environment in accordance with one embodiment of the present invention. The inventive apparatus shown in FIG. 1 includes a device group 100, a home network 102, a home network management unit 104, an application service script server 106, an application service script 108, and an application service reconfiguration unit 110.

As shown in FIG. 1, the device group 100 includes plural devices, which are connected to the home network 102. Each of the devices 100/1˜100/N may be, for example, an audio/video system, an home appliance, a home automation device or the like.

The home network management unit 104 manages home network status information of any of the devices, e.g., a device 100/1 included in the device group 100, and is linked to the application service reconfiguration unit 110 for offering application service of, e.g. the device 100/1. Here, the home network status information may be, for example, any one of status information of the home network 102 itself, status information of the device group 100 connected to the home network 102, topology information on the home network, information on the amount of the network used, and so on. Also, the home network management unit 104 may easily support the management of the status information of the device group 100 over the home network 102 by visually displaying the relation between the devices in the device group 100.

The application service script 108 is an implicit description on various services being generally provided by a home network, which is predefined regardless of devices by a developer.

The application service script server 106 manages the application service script 108. In addition, if a device connected to the home network 102 is, for example, a home appliance, the application service script server 106 delivers a corresponding application service script related to the home appliance to the application service reconfiguration unit 110.

The application service reconfiguration unit 110 analyzes the application service script from the application service script server 106 to configure a service logic, and matches the service logic with the home network status information managed by the home network management unit 104 to create a corrected application service execution plan.

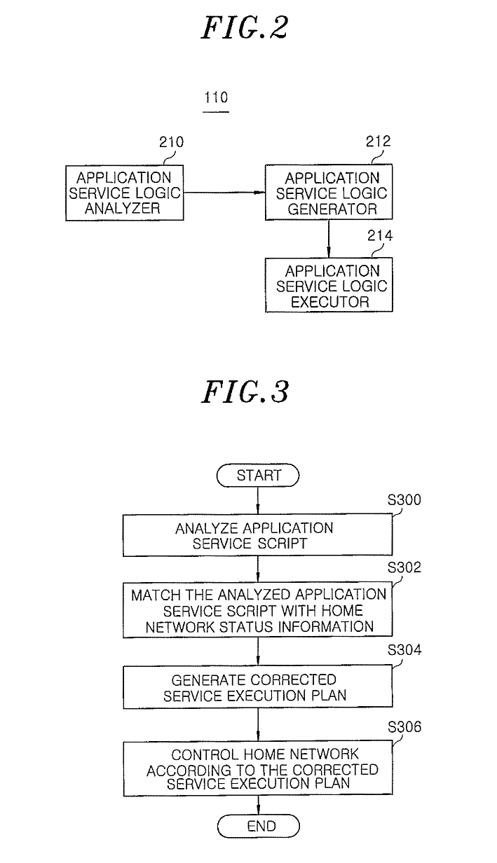

FIG. 2 provides a detailed block diagram of the application service reconfiguration unit 110 depicted in FIG. 1. As shown, the application service reconfiguration unit 110 is provided with an application service logic analyzer 210, an application service logic generator 212, and an application service logic executor 214.

The application service logic analyzer 210 serves to analyze the application service script provided from the application service script server 106.

The application service logic generator 212 matches the analyzed application service script from the application service logic analyzer 210 with the home network status information from the home network management unit 104 to correct the application service execution plan.

The application service logic executor 214 delivers the application service execution plan generated by the application service logic generator 212 to the home network management unit 104. Then, under the application service execution plan, the home network management unit 104 controls the device group 100 connected to the home network 102.

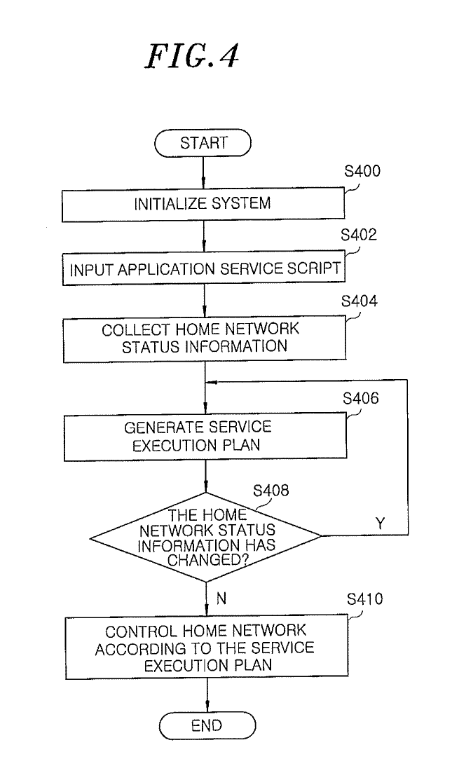

Now, a method for reconfiguring application services in home network environment in accordance with another embodiment of the present invention will be explained in detail, in parallel with the above-described configuration, with reference to FIGS. 3 and 4.

FIG. 3 illustrates a procedure of generating a corrected application service execution plan.

First, in step S300, the application service reconfiguration unit 110 analyzes an application service script from the application service script server 106 for preparing application service execution plan.

Next, in step S302, the application service reconfiguration unit 110 matches the analyzed application service script with home network status information from the home network management unit 104.

By matching the application service script with the home network status information, the application service execution plan is generated by the application service reconfiguration unit 110 in step S304, and then forwarded to the home network management unit 104.

Lastly, in step S306, the home network management unit 104 controls the device group 100 connected to the home network 102 in accordance with the corrected application service execution plan.

Meanwhile, there may be a change in home network environment, for example, existing device, network, system or service may be changed or another one may be added. In this case, home network status information is necessarily changed.

FIG. 4 illustrates a procedure of regenerating an application service execution plan depending on whether there is a change in the home network status information.

First, when a system is initialized in step S400, an application service script is provided from the application service script server 106 to the application service reconfiguration unit 110 in step S402.

Next, in step S404, the application service reconfiguration unit 110 collects the home network status information from the home network management unit 104.

Thereafter, the application service reconfiguration unit 110 matches the application service script with the home network status information to generate an application service execution plan in step S406, and then delivers the generated application service execution plan to the home network management unit 104.

Then, in step S408, the home network management unit 104 checks whether there is a change in the home network status information over the home network 102 at present. If there is no change in the home network status information, the home network management unit 104 controls the home network 102 based on the currently generated application service execution plan in step S410.

If there is a change in the home network status information, however, the home network management unit 104 goes back to the step S406 to request the application service reconfiguration unit 110 to regenerate the application service execution plan.

In the same manner, when the application service execution plan is regenerated by the application service reconfiguration unit 110, the home network management unit 104 controls the home network 102 in accordance with the regenerated application service execution plan.

As described above, the present invention may be implemented in a way to match the application service script with the home status information to generate the application service execution plan, and then to control the home network in accordance with the generated application service execution plan.

It will be appreciated to those skilled in the art that the particular embodiments described above are provided to illustrate the invention without limiting its scope in any way, and many other embodiments may be designed without departing from the scope of the invention defined in the following claims. Also, it should be noted that terms like “comprise”, “comprising”, etc., are not to exclude the existence of components or steps that are not listed in claims or specification overall. A singular reference of a component does not exclude plural references of such a component, and vice versa. The present invention may be practiced by hardware devices including some of separate components and by suitably programmed computer devices. In claims listing several devices, some of those devices may be implemented by an item such as hardware. A simple fact that certain devices are described in different dependent claims does not necessarily indicate that combinations of such means cannot be used.

As mentioned earlier, the present invention can effectively support operations of the application service by correcting them through the use of the application service script and the home network status information in the home network environment where plural devices are controlled and executed.

With the present invention, resources can be selected by adding an application service script matching method whenever there is an addition of any type of home networks, devices, systems, services, etc., and thus, the invention can be efficiently applied to a variety of application fields such as home network's maintenance, and so on.

While the invention has been shown and described with respect to the embodiments, it will be understood by those skilled in the art that various changes and modification may be made without departing from the scope of the invention as defined in the following claims.

What is claimed is:

1. A method for reconfiguring application services in home network environment where plural devices included in a device group operate in conjunction with application services, comprising:
analyzing an application service script;
collecting home network status information through the home network environment; and
matching the application service script with the home network status information to generate a corrected application service execution plan.

2. The method of claim 1, further comprising controlling the home network environment in accordance with the corrected application service execution plan.

3. The method of claim 1, wherein said generating the corrected application service execution plan includes generating the application service execution plan depending on whether there is a change in the home network status information.

4. The method of claim 1, wherein said generating the corrected application service execution plan includes regenerating an application service execution plan when there is a change in the home network status information.

5. The method of claim 1, wherein the home network status information includes any one of status information of home network in the home network environment, status information of the device group connected to the home network, network topology information, and information on an amount of network used.

6. The method of claim 5, wherein the home network status information is information that relation between the devices in the device group is visually displayed.

7. An apparatus for reconfiguring application services in home network environment, comprising:
a home network management unit for managing home network status information of any of devices included in a device group connected to a home network;
an application service script server for managing an application service script; and
an application service reconfiguration unit for analyzing the application service script, and matching the analyzed application service script with the home network status information to generate a corrected application service execution plan.

8. The apparatus of claim 7, wherein the home network status information includes any one of status information of the home network in the home network environment, status information of the device group, network topology information, and information on an amount of network used.

9. The apparatus of claim 8, wherein the home network status information is information that relation between the devices in the device group is displayed visually.

10. The apparatus of claim 7, wherein the application service reconfiguration unit includes:
an application service logic analyzer for analyzing the application service script from the application service script server;
an application service logic generator for matching the application service script analyzed by the application service logic analyzer with the home network status information managed by the home network management unit to generate the corrected application service execution plan; and
an application service logic executer for providing the home network management unit with the application service execution plan generated by the application service logic generator.
